(19) United States
(12) Patent Application Publication
(10) Pub. No.: US 2011/0100057 A1
(43) Pub. Date: May 5, 2011

(54) METHOD AND APPARATUS FOR REDUCING HEAT LOSS FROM EDGE DIRECTORS IN A GLASS MAKING PROCESS

(76) Inventor: Keith R. Gaylo, (US)

(21) Appl. No.: 12/608,452

(22) Filed: Oct. 29, 2009

(51) Int. Cl. C03B 17/06

(52) U.S. Cl. 65/90; 65/199

(57) ABSTRACT

An apparatus for drawing a glass ribbon including a forming body having an edge director attached thereto, and an edge roll assembly disposed below the edge director, the edge roll assembly comprising a contact member coupled to the edge roller shaft and a thermal shroud disposed about the shaft to reduce heat loss from the edge director. A method of drawing glass using the edge roll assembly is also described.

### TECHNICAL FIELD

This invention is directed to a method and apparatus for reducing heat loss from edge directors used in a downdraw glass making process.

### BACKGROUND

One method of forming a thin sheet of glass is by a drawing process where a ribbon of glass is drawn from a reservoir of molten glass. This may be accomplished, for example, via an up-draw process, where the ribbon is drawn upward from the reservoir (e.g. Foucault or Colburn), or by a down-draw process (e.g. slot or fusion), where the ribbon is drawn downward, typically from a forming body. Once the ribbon is formed, individual sheets of glass are cut from the ribbon.

In a conventional downdraw process, the molten glass is drawn from a forming body into a glass ribbon. For example, in an exemplary fusion downdraw process molten glass is flowed over a forming body comprising a pair of converging forming surfaces. The separate flows join where the forming surfaces converge (the “root”) to produce a single ribbon of glass. Edge directors located at the root help maintain the ribbon width against surface tension effects.

Heat loss at the edge directors can cool the glass flowing over their surfaces and cause devitrification of the glass. One source of this heat loss can be traced to edge rollers located in close proximity to the root that guide the ribbon as it descends from the bottom of the forming body.

### SUMMARY

An apparatus is described for drawing a glass ribbon comprising an edge roll assembly positioned below and proximate to the root of a forming body from which molten glass is drawn to form the ribbon. The edge roll assembly includes a thermal shield, or shroud, positioned about the shaft of the edge roll to minimize the amount of heat lost through radiation, and to reduce the convective heat loss by air flowing upward through the drawing apparatus. To wit, the thermal shroud is essentially a hollow tube or can that is disposed about the shaft with an air gap between the shaft and the shroud. The shroud serves to insulate the shaft and make the shaft appear less of a heat sink to minimize heat loss from the edge director to the shaft. The air gap is open to the atmosphere on at least one end of the shroud. At least one end of the shroud is at least partially closed, and in some embodiments, completely closed so that the closed.

In one embodiment, an apparatus for drawing a glass ribbon is disclosed comprising a forming body, such as a fusion forming body, for supplying a glass ribbon, the forming body comprising converging forming surfaces that join together at a root. The forming body also includes an edge director that intersects with the root. The edge director comprises a web surface that extends between a converging forming surface and an edge dam—an essentially vertical member positioned at the ends of the forming body to constrain the flow of molten glass. In some embodiments, the edge director is fabricated from platinum or a platinum alloy, such as a platinum-rhodium alloy, and affixed to the refractory (e.g. ceramic) forming body.

Positioned directly below the forming body and proximate the edge director is an edge roll assembly comprising a contact member or roll for contacting an edge portion of the glass ribbon. An edge roll shaft is coupled to the contact member and a shroud member is disposed about the shaft proximate the contact member so that a gap exists between an outside surface of the shaft and an inside surface of the shroud member. The shaft is preferably hollow, comprising one or more passages or pipes for conveying a cooling fluid, such as air or water, through the shaft and into contact with the contact member. The contact member includes at least portions that are hollow so that the contacting cooling fluid can cool the contact member from its interior. Return passages are also provided in the shaft so that the colling fluid can be removed from the shaft and contact member. For example, for recycling of the cooling fluid.

Preferably, the shroud member is concentric with the shaft and is hollow (with the exception of the shaft extending therethrough or supports, if present). In some embodiments, a low emissivity material may be chosen from which to fabricate the shroud member. The shroud member is positioned adjacent to the contact member, and extends from the contact member over and about at least a portion of the shaft, forming a annular gap between the shaft and the inner surface of the shroud member. The shroud member may have one end closed off, such as by fixing the shroud member to an end of the contact member so that an interior volume is defined by the boundaries of the shaft, the interior of the shroud member and the end of the contact member.

In some instances the edge roll shaft is coupled to a driving device configured to rotate the shaft. For example, the edge roll shaft may be coupled to an electric motor. The shroud member diameter is equal to or less than a maximum outside diameter of the contact member, but with an inside diameter greater than the shaft so that an annular gap is formed between the inside surface of the shroud and an outside surface of the shaft.

In some embodiments, the edge roll assembly comprises a plurality of shroud members, and wherein each shroud member of the plurality of shroud members is concentric with an adjacent shroud member and a gap exists between adjacent shroud members. As before, the shroud members may be coupled to the shaft, or the shroud members may be coupled to an external portion of the drawing apparatus so that the shrouds do not rotate with the shaft.

In another embodiment, an edge roll assembly for drawing a glass ribbon from a forming body is described comprising a contact member for contacting an edge portion of the glass ribbon, an edge roll shaft coupled to the contact member and a shroud member disposed concentrically about the shaft so that a gap exists between an outside surface of the shaft and an inside surface of the shroud member. The shroud member may extend, for example, greater than one half the shaft length, but preferably extends from the contact member at least 10 cm. The edge roll shaft is preferably configured to be driven by a driving device to rotate the shaft and the contact member. The outside diameter of the shroud member is preferably equal to or less than a maximum outside diameter of the contact member. In some instances the edge roll assembly comprises a plurality of shroud members concentrically disposed about the shaft. The shroud member may be coupled to the shaft.

In still another embodiment, a method of drawing glass is described comprising producing a continuous ribbon of glass in a downdraw process contacting the continuous ribbon of glass with an edge roll assembly comprising a contact member for contacting an edge portion of the glass ribbon, an edge roll shaft coupled to the contact member and a shroud member concentrically disposed about the shaft proximate the contact member so that a gap exists between an outside surface of the shaft and an inside surface of the shroud member.

The invention will be understood more easily and other objects, characteristics, details and advantages thereof will become more clearly apparent in the course of the following explanatory description, which is given, without in any way implying a limitation, with reference to the attached Figures. It is intended that all such additional systems, methods, features and advantages be included within this description, be within the scope of the present invention, and be protected by the accompanying claims.

### BRIEF DESCRIPTION OF THE DRAWINGS

FIG. 1 is partial cross sectional perspective view of an exemplary fusion forming body comprising an edge director and a pair of edge roll assemblies positioned below the edge director.

FIG. 2 is a front view of a portion of the apparatus of FIG. 1 showing the placement of the edge roll and thermal shroud relative to the edge director.

FIG. 3 is a perspective view of an embodiment according to the present invention showing an edge roll assembly including a thermal shield or shroud disposed about a shaft of the edge roll assembly.

FIG. 4 is another embodiment of an edge roll according to the present invention wherein a plurality of concentric thermal shrouds are coupled to the edge roll.

### DETAILED DESCRIPTION

In the following detailed description, for purposes of explanation and not limitation, example embodiments disclosing specific details are set forth to provide a thorough understanding of the present invention. However, it will be apparent to one having ordinary skill in the art, having had the benefit of the present disclosure, that the present invention may be practiced in other embodiments that depart from the specific details disclosed herein. Moreover, descriptions of well-known devices, methods and materials may be omitted so as not to obscure the description of the present invention. Finally, wherever applicable, like reference numerals refer to like elements.

In an exemplary fusion-type downdraw process, molten glass is supplied to a forming body comprising a channel open at its top in an upper surface of the forming body. The molten glass overflows the walls of the channel and flows down converging outside surfaces of the forming body until the separate flows meet at the line along which the converging surfaces meet (i.e. the “root”). There, the separate flows join, or fuse, to become a single ribbon of glass that flows downward from the forming body.

The ends of the forming body are usually fitted with edge directors that guide the edges of the glass flow to form stable beads of thicker cross-section than the body of the ribbon and can help to maintain the width of the ribbon against surface tension by effectively increasing the length of the root.

Various rollers (or “rolls”) positioned along the edges of the ribbon serve to draw, or pull the ribbon downward and/or apply a tensioning force to the ribbon that also helps maintain the width of the ribbon. Some rolls may be rotated by motors, whereas other rolls are free-wheeling. The edge rolls are arranged in pairs that pinch the ribbon of glass therebetween. Thus, for a given vertical location down the length of the ribbon, one pair of edge rolls will be arranged at one edge of the ribbon and a second pair of edge rolls positioned at the same vertical position at the other edge of the ribbon for a total of four rolls.

The substantially uniform horizontal thermal environment that the body of the glass sheet is exposed to along the sides of the forming body is disrupted by the geometrical conditions around either end of the forming body. Thus, the ends of the forming body are exposed to a substantially larger surface area at a colder temperature than the body of the glass flow on the forming body. In particular, edge rolls immediately below the edge directors are actively maintained at a substantially lower temperature to prevent the hot glass from sticking to them. For example, a working fluid, represented by numeral 6, such as air, can be flowed through passages, such as pipe 8 in the edge roll shaft and impinged on an inside surface of the roll contact member (the portion of the edge roll assembly contacting the molten glass) to cool the contact member (see FIG. 2). More than one cooling passage through the shaft may be provided.

The openings between and around the edge roll shafts also expose the edge directors to colder surfaces lower in the draw apparatus. Moreover, the geometry of the edge directors spreads and slows the glass flow over them, allowing the glass on the edge directors more time to cool, and at a higher cooling rate, than glass on the sides of the forming body. The edge directors also have a larger surface area directly exposed to convective and radiative heat loss than the forming body itself.

Heat losses from the edge directors drive the temperature of the glass flowing over them to be lower than glass at the root of the forming body. This low glass temperature at the edge directors should ideally be near or above the glass liquidus temperature to avoid devitrification build up on the edge directors. If the temperature of the glass is substantially below the liquidus temperature of the glass, rapid build up of devitrification occurs that may eventually lead to glass flow instability and poor sheet forming characteristics. Devitrified glass build up on the edge directors can also contaminate the molten glass if it breaks off and becomes entrained in the glass flow.

Currently, glass compositions for drawing are selected to have a sufficiently low liquidus temperature (or high liquidus viscosity) to avoid the worst of devitrification problems. For glass compositions having a relatively low liquidus viscosity, the devitrification build up rate is a major contributor to limiting the operating life of the glass forming apparatus (e.g. forming body and or edge directors) before repair of the apparatus is necessary. Past attempts at flowing much hotter glass than normal over the forming body in an attempt to re-melt the devitrification, and attempts at mechanically scraping the devitrification from the edge directors have been unsuccessful at mitigating the problem.

The devitrification build up is driven by a glass temperature pattern across the forming body and the edge director where temperature is highest at the root center of the forming body and drops sharply across the edge directors. Typically, the glass on the lower regions of the edge directors falls below the liquidus temperature, promoting a build up of devitrification. If the glass temperature is sufficiently below the liquidus temperature and the glass is flowing slowly enough, the devitrification build up rate will be high enough to eventually disrupt the flow of glass over the edge directors, making the sheet forming process difficult to manage.

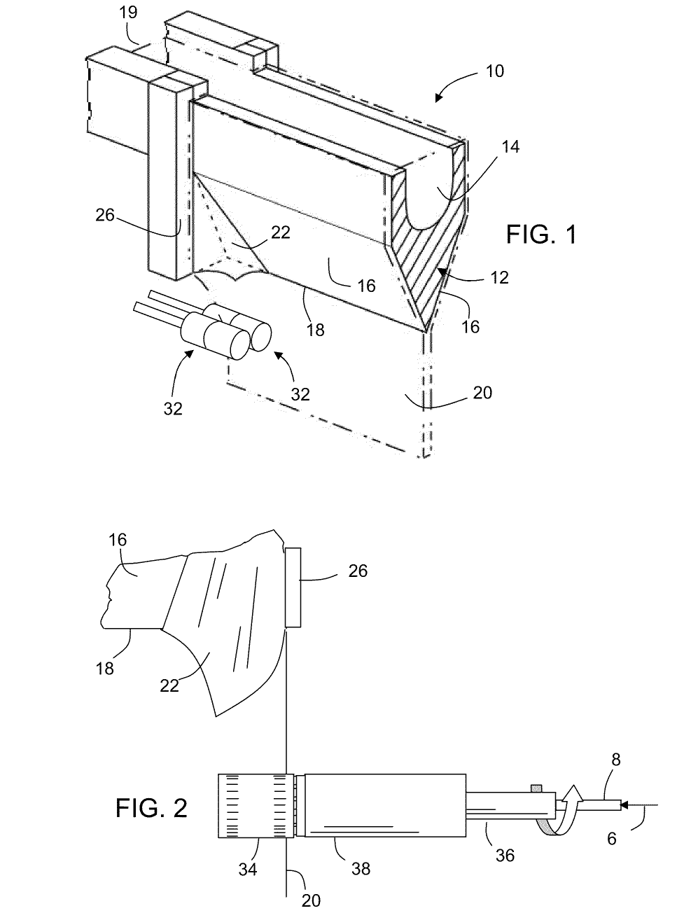

Shown in FIG. 1 is an exemplary fusion downdraw apparatus 10 according to one embodiment comprising forming body 12 including channel or trough 14 and converging forming surfaces 16. Converging forming surfaces 16 meet at root 18. Trough 14 is supplied from a source (not shown) with molten glass 19 that overflows the walls of the trough and descends over the outer surfaces of the forming body as separate streams. The separate streams of molten glass flowing over converging forming surfaces 16 meet at root 18 and form glass ribbon 20. As the ribbon descends from the forming body, the molten material transitions from a viscous state at the bottom of the forming body, to a visco-elastic state and finally to an elastic state.

When glass ribbon 20 has reached a final thickness and viscosity, the ribbon is separated across its width to provide an independent glass sheet or pane. As molten glass continues to be supplied to the forming body, and the ribbon lengthens, additional glass sheets are separated from the ribbon.

Edge director 22 comprises a web portion 24 that extends between a converging forming surface 16 and edge dam 26. In some embodiments, a portion of web portion 24 extends below root 18. However, the edge director illustrated in FIG. 1 is for illustration purposes only, and other edge director designs are possibly. In total, there are four edge director web portions, one for each corner of the forming body. In certain embodiments, heating elements (not shown) may be disposed within the edge director web portions to heat the edge directors.

Edge roll assemblies 32 are positioned at predetermined vertical locations below edge director 22, and may include driven edge rolls used to apply a pulling force to the ribbon and/or non-driven idler rolls that guide the ribbon and help maintain a tension across the ribbon width. Driven edge rolls are driven by a driving device, usually an electric motor. Edge rolls are typically arranged in pairs, each roll of a roll pair positioned on opposite sides of an edge of the ribbon. Additionally, edge roll pairs are themselves arranged in pairs, one pair of rolls per ribbon edge at a given vertical position.

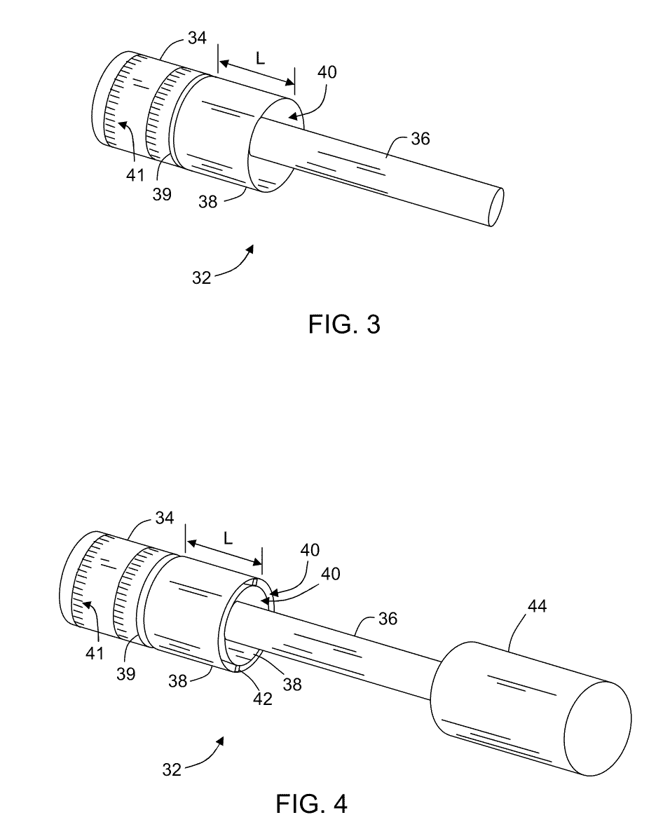

FIG. 3 illustrates an exemplary edge roll assembly 32 according to one embodiment. Edge roll assembly 32 comprises a contact member 34, edge roll shaft 36 and thermal shield or shroud 38. Shroud 38 comprises a cylinder or tube fitted over the edge roll shaft. The tube is preferably concentric with the shaft. Shroud 38 may be coupled to edge roll shaft 36, such as through flange 39. Alternatively, shroud 38 may be coupled to contact member 34. In some embodiments, shroud 38 may be independently floated about shaft 36. That is, shroud 38 may be coupled to an external support such that the shroud is not attached to the edge roll shaft and does not rotate with the shaft. Air gap 40 between the inside wall of the shroud and the outside surface of edge roll shaft insulates shroud 38 from shaft 36 so that most of the heat transfer between the surrounding environment and the shaft consists substantially of a series of absorption-conduction-radiation resistances which greatly impede this heat transfer. In some embodiments, the outside surface of contact member 34 is textured, such as by knurling 41, to improve the grip between the contact surface and the glass. Air gap 40 extends 360 degrees around shaft 36 except that in some embodiments, as described below, the gap may be interspersed with spacers or spokes.

In another embodiment shown in FIG. 4, a plurality of thermal shields or shrouds 38 of increasing radius are concentrically disposed about edge roll shaft 36, with an air gap 40 between each shroud and an adjacent shroud (or the edge roll shaft for the inner-most shroud member) thus increasing the shielding effect by increasing the total thermal resistance. If necessary, spacers (e.g. spokes) 42 between concentric cylinders may be used to maintain a uniform gap between cylinders. However, the area of contact between these supports and the cylinders should be minimized to reduce any thermal conduction path as much as possible. Edge roll assembly 32 of FIG. 4 is shown including drive motor 44.

The one or more shrouds 38 may extend the full exposed length of shaft 36 from the base of roll contact member 34 that contacts the edge of glass ribbon 20 to drive motor 44, or they may only cover a portion of shaft 36. The length of the shroud is limited only by the space available in the draw apparatus. However, preferably, each shroud has a length L of at least 10 cm. The outside diameter of the outermost shroud 38 should be larger than the diameter of shaft 36 so a gap is provided between the inside surface of the shroud and the outside surface of the shaft, but may be as large as the diameter of the widest portion of roll contact member 34. A diameter substantially the same as the diameter of the contact member reduces the gap formed between the shafts of edge roll pairs when the edge rolls are pinched against the glass ribbon and minimizes the line of sight vector or “view” between the edge director and lower portions of the draw apparatus and may also reduce radiation heat transfer to these colder surfaces. A diameter larger than the diameter of the contact surface is impeded by the close proximity of the roll pair when they are pinched together (the two shrouds of the pair may contact). A secondary effect of maximizing the diameter of the outermost shroud is that air flow upward past the edge rolls to the edge directors will be substantially blocked, thereby reducing the convective heat loss from the edge director. It should be understood that the downdraw process has the hottest temperature at the top of the draw apparatus, creating a significant chimney effect with air flowing upward through the drawing apparatus.

The most important section of the edge roll shaft to be shielded is the part closest to the actual roll contact member. This section has the most direct view of the edge director above and therefore the most influence on edge director temperature. Thus, the shroud is located as close to the contact member as possible.

Shrouds 38 may be mechanically coupled to the shaft, for example, via flange 39 and fixed by screws, or welded. These fastenings carry no traction or radial load, and are only used to fix the shroud in place relative to the shaft. In some embodiments, the shroud may be coupled to an external component of the draw apparatus so that the shroud is not coupled to the shaft and does not rotate with the shaft.

Shrouds 38 interrupt the thermal radiation view factor from the ends of forming body 12 and edge directors 22 to two substantially colder objects: The edge roll shafts 36, that are internally cooled to prevent sticking of molten glass, and; the view between and around the shafts to the lower portion of the draw apparatus, which is typically at a much lower temperature than the forming body to cool the glass ribbon as it is drawn downward. Shrouds 38 thus help isolate edge directors 22 and other upper portions of the draw apparatus from excess heat loss at the edges.

It should be emphasized that the above-described embodiments of the present invention, particularly any “preferred” embodiments, are merely possible examples of implementations, merely set forth for a clear understanding of the principles of the invention. Many variations and modifications may be made to the above-described embodiments of the invention without departing substantially from the spirit and principles of the invention. For example, embodiments of the thermal shield or shroud, as disclosed herein, can be used in other, non-fusion glass making processes that have need of insulated edge rolls that do not function as heat sinks to other portions of the apparatus and/or glass. All such modifications and variations are intended to be included herein within the scope of this disclosure and the present invention and protected by the following claims.

What is claimed is:

1. An apparatus for drawing a glass ribbon comprising:
a forming body for supplying a glass ribbon, the forming body comprising converging forming surfaces that join together at a root;
and edge director intersecting the root;
an edge roll assembly disposed below the edge director comprising:
a contact member for contacting an edge portion of the glass ribbon;
an edge roll shaft coupled to the contact member; and
a shroud member disposed about the shaft proximate the contact member so that a gap exists between an outside surface of the shaft and an inside surface of the shroud member.

2. The apparatus according to claim 1, wherein the shroud member is concentric with the shaft.

3. The apparatus according to claim 1, wherein the edge roll shaft is coupled to a driving device configured to rotate the shaft.

4. The apparatus according to claim 1, wherein an outside diameter of the shroud member is equal to or less than a maximum outside diameter of the contact member.

5. The apparatus according to claim 1, wherein the edge roll assembly comprises a plurality of shroud members, and wherein each shroud member of the plurality of shroud members is concentric with an adjacent shroud member and a gap exists between adjacent shroud members.

6. The apparatus according to claim 1, wherein the shroud member is coupled to the shaft.

7. The apparatus according to claim 1, wherein the shroud member wherein at least one end of the shroud member is open to the atmosphere.

8. The apparatus according to claim 1, wherein the shroud member is at least partially closed at one end.

9. The apparatus according to claim 1, wherein the shroud member comprises a tube.

10. The apparatus according to claim 1, wherein the edge roll assembly is positioned directly below the forming body proximate the edge director.

11. An edge roll assembly for drawing a glass ribbon from a forming body comprising;
a contact member for contacting an edge portion of the glass ribbon;
an edge roll shaft coupled to the contact member; and
a shroud member disposed concentrically about the shaft so that a gap exists between an outside surface of the shaft and an inside surface of the shroud member.

12. The edge roll assembly according to claim 11, wherein the shroud member extends greater than one half the shaft length.

13. The edge roll assembly according to claim 11, wherein the edge roll shaft is configured to be driven by a driving device to rotate the shaft, and the shroud member rotates with the shaft.

14. The edge roll assembly according to claim 11, wherein an outside diameter of the shroud member is equal to or less than a maximum outside diameter of the contact member.

15. The edge roll assembly according to claim 11, wherein the edge roll assembly comprises a plurality of shroud members concentrically disposed about the shaft.

16. The edge roll assembly according to claim 11, wherein the shroud member is coupled to the shaft.

17. A method of drawing glass comprising;
flowing molten glass over a forming body to produce a ribbon of glass, the molten glass flowing over at least one edge director;
contacting the ribbon of glass with an edge roll assembly comprising:
a contact member for contacting an edge portion of the glass ribbon;
an edge roll shaft coupled to the contact member; and
a shroud member concentrically disposed about the shaft proximate the contact member so that an annular gap exists between an outside surface of the shaft and an inside surface of the shroud member to reduce radiative heat loss from the edge director.

18. The method according to claim 17, wherein the edge roll shaft is rotated and the shroud member rotates with the shaft.

19. The method according to claim 17, wherein the forming body comprises converging forming surfaces over which the molten glass flows in separate streams, and the edge director is attached to one of the converging forming surfaces.
